(19) United States
(12) Patent Application Publication
(10) Pub. No.: US 2010/0207599 A1
(43) Pub. Date: Aug. 19, 2010

(54) ELECTRIC MOTOR DRIVE UNIT FOR ON-LOAD TAP-CHARGERS

(75) Inventors: Håkan Blomquist, Smedjebacken (SE); Martin Perols, Smedjebacken (SE); Jan Ekengren, Borlange (SE); Jean Mathae, Sandviken (SE); Lahan Konov, Ludvika (SE); Lars G. Eriksson, Ludvika (SE); Tommy Fräsén, Gagnef (SE); Helge Österholm, Ludvika (SE); Per Eriksson, Borlange (SE)

Correspondence Address: VENABLE LLP, P.O. BOX 34385, WASHINGTON, DC, 20043-9998, US

(73) Assignee: ABB TECHNOLOGY LTD., Zurich (CH)

(21) Appl. No.: 12/438,738

(22) PCT Filed: Aug. 22, 2007
(86) PCT No.: PCT/SE2007/000740

§ 371 Date: Apr. 22, 2010

(30) Foreign Application Priority Data
Aug. 25, 2006 (SE) 0601739-6

(51) Int. Cl. H01F 29/04

(52) U.S. Cl. 323/355

(57) ABSTRACT

A motor drive cabinet in an on-load tap-changer, including an electric motor drive unit and a control unit. The electric motor drive unit includes an electric motor, a gearbox and a position transmitter. The control unit is arranged to control an outgoing axis outgoing from the motor drive cabinet by feeding the electric motor through direct connection to drive the outgoing axis through the gearbox. The position transmitter is arranged to detect movement and position of the outgoing axis and to provide indications thereof to the control unit. The motor drive cabinet is sealed during use with the electric motor drive unit and control unit within the sealing.

### FIELD OF INVENTION

The present invention relates generally to on-load tap-changers and more particularly to an electric motor drive unit for an on-load tap-changer.

### BACKGROUND

An on-load tap-changer is normally used in power transformers in an electric grid, where its function primarily is to keep a constant voltage out from the transformer. Some on-load tap-chargers are used in transformers where their function is to control the power of the transformer by regulating the voltage. The on-load tap-changer can be described as a mechanical switching device that will change the turn ratio in the transformer without interrupting the load current. This makes it possible to keep a constant voltage out from the transformer and to compensate for variations in the load.

A common on-load tap-changer generally consists of a motor drive unit, an axis system, a diverter switch with a housing, and a selector mounted under the diverter switch. Such an on-load tap-changer is named a diverter switch type. Another on-load tap-changer, wherein the selector and the diverter switch are merged into the same unit is named a selector switch type.

The main objective of an electric motor drive unit is to drive the connected on-load tap-changer to a higher or a lower tap of a transformer.

Electric motor drive units for tap changers are rather complex and the cost for their production and assembly is considerable. Further, electric motor drive units are to a large extent order designed, with a customer requirement as basis, which further increases cost for their production and assembly.

### SUMMARY OF THE INVENTION

An object of the present invention is to provide an electric motor drive unit for tap-changers which is adaptable to different customer requirements.

The invention is based on the realization that by providing an on-load tap-changer with an electric motor drive unit at a minimum the following advantages are achieved:

Reduced lead time in production

Flexibility for late order changes

Service friendly design

Reduced tap-changer motor drive cost

According to a first aspect of the present invention there is provided a motor drive cabinet as defined in appended claim 1.

According to a second aspect of the present invention there is provided an on-load tap-changer as defined in appended claim 8.

Further preferred embodiments are defined by the dependent claims.

### BRIEF DESCRIPTION OF DRAWINGS

The present invention will become more fully understood from the detailed description of embodiments given below and the accompanying drawings, which are given by way of illustration only, and thus, are not limitative to the present invention, in which:

FIG. 1 schematically shows a tap changer; and

FIG. 2 schematically shows a motor drive cabinet.

### DETAILED DESCRIPTION OF PREFERRED EMBODIMENTS

In the following description, for purpose of explanation and not limitation, specific details are set forth, such as particular techniques and applications in order to provide a thorough understanding of the present invention. However, it will be apparent for a person skilled in the art that the present invention may be practiced in other embodiments that depart from these specific details. In other instances, detailed description of well-known methods and apparatuses are omitted so as not to obscure the description of the present invention with unnecessary details.

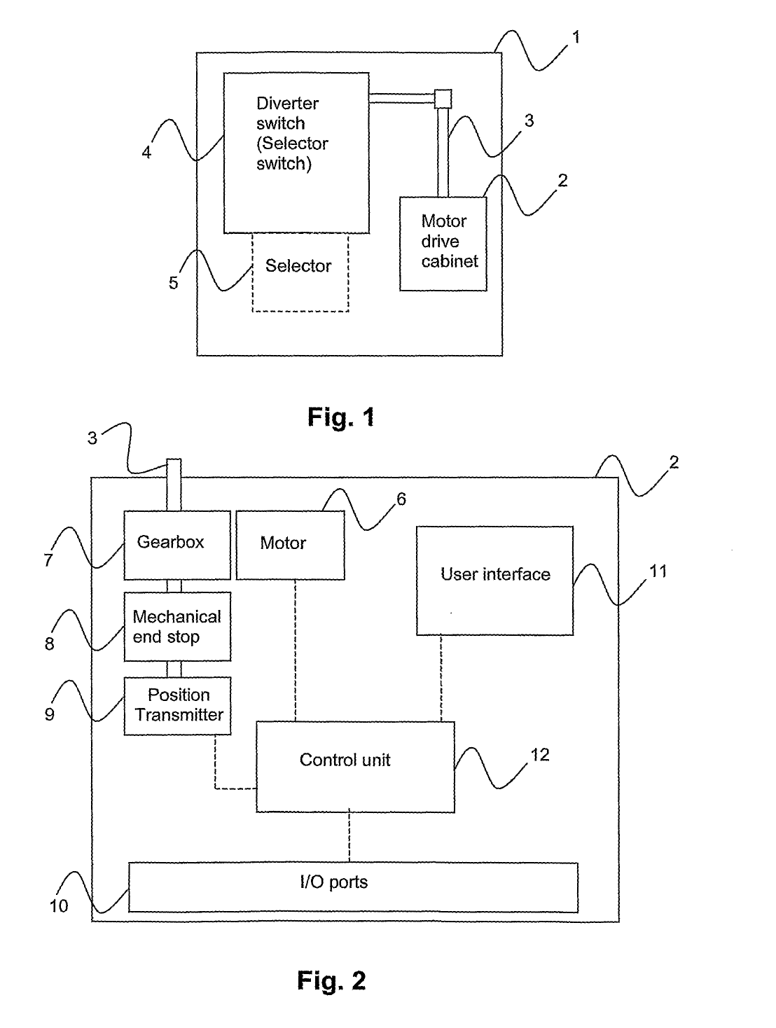

An embodiment of the present invention will now be described with reference to FIGS. 1-2.

An on-load tap-changer 1 comprises a motor drive cabinet 2, an axis system 3, diverter switch 4, and a selector 5 mounted below the diverter switch 4. Alternatively, the selector 5 and the diverter switch 4 are merged into the same unit.

The motor drive cabinet 2 houses an electric motor drive unit. The motor drive cabinet 2 is during use sealed and provided with an internal climate control to control at least humidity and temperature in the motor drive cabinet 2, which thereby protects the electric motor drive unit from hard environmental conditions that usually are generated near high voltage transformers.

The electric motor drive unit comprises an electric motor 6, a gearbox 7, a mechanical end stop 8, a position transmitter 9, I/O ports 10, a user interface 11, and a control unit 12 to control the electric motor drive unit. The electric motor 6 is arranged to drive the on-load tap-changer through an outgoing axis 3, which is connected to the axis system 3. The outgoing axis 3 exits the motor drive cabinet 2 through a tight joint.

The gearbox 7 is used between the electric motor 6 and the outgoing axis 3 to reduce the number of turns from the electric motor 6 to the outgoing axis 3. The electric motor 6 is preferably a standard three-phase motor with multi-adaptable power supply from a frequency converter in the control unit 12. The electric motor 6 can in this way be supplied by 110-440 AC/DC. The mechanical end stop 8 is preferably provided in the electric motor drive unit to prohibit the electric motor 6 to drive the on-load tap-changer 1 beyond its upper and lower end positions. Further, the mechanical end stop 8 is advantageously included within the gearbox 7. Manual operation of the electric motor drive unit 2 is preferably provided by the use of a hand crank arranged in the mechanical end stop 8. Further, to keep track of absolute on-load tap-changer position and movement a position transmitter 9 is arranged on the outgoing axis 3. The position transmitter 9 collects status related to both movement and position, such as end-positions, erroneous behavior and/or indications of the outgoing axis 3, and thus of the on-load tap-changer. The position transmitter 9 is used in such a way that it enables absolute on-load tap-changer position detection. Further, the electric motor need not be provided with a dedicated brake, since the gearbox 7 preferably is provided as self retarding, and the electric motor also can be short circuited for effective braking.

The user interface 11 is used for interaction with an operator. A graphical display is preferably used to show information about status and actual settings. Menu navigation is preferably utilized by means of a touch panel on the display. Examples of real-time display information are: actual position of on-load tap-changer, current max/min position (resetable), number of operations, alarm and error handling, and setting. The touch panel further preferably comprises buttons for manual operation of the electric motor drive unit, local-off-remote switch and function-dedicated buttons, which are provided as required by relevant standards. Additional buttons may be used as input devices for menu navigation and subsequently selecting and executing commands via the display. The user interface 11 is preferably accessible from outside of a sealed motor drive cabinet 2, for possible run time configurations.

The control unit 12 is the centre of the motor drive cabinet 2 and maintain the overall control of all operation, configuration and signalling of the electric motor drive unit for the on-load tap-changer. One part of the control unit 12 is a motor power stage. This motor power stage is used to feed power to the electric motor 6. This power is fed through direct connection between the control unit 12 and the electric motor 6, which makes it possible to omit contactors there between, which contactors take up space, limit drive flexibility of the electric motor, and adds production and testing time. Feedback to the control unit 12 is taken from the position transmitter 9 and current and voltage measuring from the motor power stage. Parameters, which preferably are collected by the control unit 12 and also used to control the electric motor drive unit, are e.g. speed of rotation, direction of rotation and ramp speed. The control unit 12 in this way controls and supervises the operation of the electric motor 6. The motor power stage is arranged to provide the same output independent of input of multi voltage, multi frequency, and dual type (AC/DC). In this way the motor drive cabinet 2 also can be reconfigured during run time.

Signalling in the motor drive cabinet 2 is preferably over a bus, exemplified by Control Area Network (CAN). In this way the motor drive cabinet 2 can be further easily adapted to e.g. late order changes.

Signalling in/out of the motor drive cabinet 2 is preferably provided by I/O ports 10. The I/O ports are equipped to handle different types and numbers of I/O signals, such as digital and analogue signals as well as in and out signals. The motor drive cabinet 2 is preferably provided with a standard set of ports, which preferably are software configurable to make connection to and from the required sender/recipient within their capabilities. The digital in-signal is preferably arranged to handle both AC of widely varying frequency and voltages as well as DC of varying voltages.

By providing the motor drive cabinet 2 with a standard set of I/O ports 10, which ports are configurable, an electric motor 6 and a standard gearbox 7, which are configurable through parameters in the control unit 12, building time is reduced to about one sixth of prior building time. Further, testing time is also reduced to about one sixth of prior building time with the motor drive cabinet 2 of the present invention.

It will be obvious that the present invention may be varied in a plurality of ways. Such variations are not to be regarded as departure from the scope of the present invention as defined by the appended claims. All such variations as would be obvious for a person skilled in the art are intended to be included within the scope of the present invention as defined by the appended claims.

1. A motor drive cabinet (2) in an on-load tap-changer, comprising an electric motor drive unit and a control unit (12), said motor drive cabinet being characterized in that said electric motor drive unit comprises an electric motor (6), a gearbox (7) and a position transmitter (9), wherein said control unit (12) is arranged to control an outgoing axis (3) outgoing from said motor drive cabinet (2) by feeding said electric motor (6) through direct connection to drive said outgoing axis (3) through said gearbox (7), and wherein said position transmitter (9) is arranged to detect movement and position of said outgoing axis (3) and to provide indications thereof to said control unit (12), and wherein said motor drive cabinet (2) is sealed during use with said electric motor drive unit and control unit (12) inside said sealed motor drive cabinet (2).

2. The motor drive cabinet (2) according to claim 1, comprising a mechanical end stop (8) on said axis, wherein said gearbox (7) comprises said mechanical end stop (8) and is arranged to mechanically prevent the outgoing axis (3) from being driven beyond desired end positions.

3. The motor drive cabinet (2) according to claim 1 or 2, comprising a user interface (11) arranged to control the control unit (12), which user interface (11) is accessible from outside of the sealing.

4. The motor drive cabinet (2) according to any of claims 1-3, comprising reconfigurable I/O ports (10) arranged to provide said motor drive cabinet (2) with flexible connection points.

5. The motor drive cabinet (2) according to any of claims 1-4, comprising a climate control equipment.

6. The motor drive cabinet (2) according to any of claims 1-5, wherein said control unit comprises a list of parameters for controlling said electric motor drive unit.

7. The motor drive cabinet (2) according to any of claims 1-6, wherein said control unit (12) is reconfigurable during run time.

8. An on-load tap-changer (1) comprising a motor drive cabinet (2) connected through an axis system (3) to a diverter switch (4) and a selector (5), or to a selector switch (4), characterized in that said motor drive cabinet (2) is provided according to any of claims 1-7.
